(19) United States
(12) Patent Application Publication
(10) Pub. No.: US 2024/0052499 A1
(43) Pub. Date: Feb. 15, 2024

(54) HIGH PERFORMANCE ALUMINA-FORMING MULTI- ELEMENT MATERIALS FOR HIGH TEMPERATURE APPLICATIONS

(71) Applicants: Zhihong Tang, Carmel, IN (US); William J. Jarosinski, Carmel, IN (US); Molly M. O'Connor, Hickory Hills, IL (US)

(72) Inventors: Zhihong Tang, Carmel, IN (US); William J. Jarosinski, Carmel, IN (US); Molly M. O'Connor, Hickory Hills, IL (US)

(21) Appl. No.: 18/364,110

(22) Filed: Aug. 2, 2023

Related U.S. Application Data
(60) Provisional application No. 63/396,335, filed on Aug. 9, 2022.

(51) Int. Cl. C23F 11/18

(52) U.S. Cl. CPC C23F 11/187

(57) ABSTRACT

Novel alumina-forming and multi-element materials are provided that can enable operation of gas turbine components and other components exposed to high temperature applications. The formulations represent a notable departure and improvement from conventional materials such as MCrAlY.

### RELATED APPLICATIONS

The present application claims the benefit of priority from U.S. Provisional Application Ser. No. 63/396,335, filed Aug. 9, 2022, which is incorporated by reference herein in its entirety.

### FIELD OF THE INVENTION

The invention relates to novel formulations that result in improved environmental performance for components that are exposed to high temperatures, such as gas turbine components. In particular, the invention relates to new alumina-forming and multi-element materials.

### BACKGROUND OF THE INVENTION

The hot-section components of aircraft, industrial and marine gas turbine engines operate in aggressive environments characterized by high-temperature, high-pressure, and the presence of oxidizing and corrosive species in the atmosphere. These harsh operating environmental conditions require structural turbine components with high-temperature capability under load to meet stringent durability and reliability criteria required by the industry.

Ni-based and Co-based superalloys have been widely used in hot section components of gas turbine engines such as blades, nozzles and combustors as a result of their superior high-temperature mechanical properties compared to other materials. Although these Ni-based and Co-based superalloys have desirable mechanical properties at high temperatures, they also have drawbacks. In particular, they typically exhibit insufficient resistance to environmental degradation that can occur by oxidation, corrosion and/or heat damage.

To enhance the environmental performance of Ni-based or Co-based superalloys, protective coatings are typically applied onto their respective surfaces. The preferred protective coating is MCrAlY (M=Ni, Co, or NiCo) that is recognized an overlay coating for high-temperature applications. Numerous US Patent Nos. describe various MCrAlY coating compositions for this purpose. For example, U.S. Pat. No. 3,676,085 describes a CoCrAlY coating; U.S. Pat. No. 3,754,903 discloses a NiCrAlY coating; and U.S. Pat. No. 3,928,026 discloses a NiCoCrAlY coating.

Further performance improvements to MCrAlY are achieved by minor additions of hafnium Hf, Si and Re. For example, U.S. Pat. No. 4,585,481 discloses the addition of 0.1-7 wt % Si and 0.1-2 wt % Hf into NiCoCrAlY coatings which results in about 3 to 4 times the life at high-temperature compared to a similar coating without these additions. U.S. Pat. No. 5,154,885 describes that 1-20 wt % Re additions into MCrAlY can increase service life. However, Re is an expensive material to utilize in such additions.

Notwithstanding the improved performance resulting from the above mentioned elemental additions to MCrAlY coatings, there continues to be a need for improved protective materials including protective coatings for Ni-based and Co-based superalloys that are suitable for use in high-temperature applications.

### SUMMARY OF THE INVENTION

In a first aspect of the present invention, an alumina-forming and multi-element material suitable for usage in high-temperature applications, the material comprising the following formulation based on a total weight of the material: 12 to 24 weight percent of nickel; 12 to 24 weight percent of cobalt; 12 to 24 weight percent of iron; 12 to 24 weight percent in total of refractory elements comprising at least one of niobium, tantalum, tungsten, titanium and vanadium; 12 to 24 weight percent of chromium; 6 to 13 weight percent of aluminum wherein a weight ratio of the aluminum to the chromium is in the range of 0.3 to 0.9; 0.1 to 2 weight percent in total of rare earth elements comprising at least one of hafnium, yttrium, zirconium and other rare earth elements; whereby each of the nickel, cobalt, iron, chromium and the refractory elements has a concentration of no more than 24 weight percent.

In a second aspect of the present invention, a method of protecting a substrate from high-temperature oxidation and corrosion, comprising the steps of: providing a substrate made of a nickel-based or a cobalt-based superalloy or a refractory-metal alloy; applying onto the substrate an alumina-forming and multi-element coating, said coating comprises the following elements: 12 to 24 weight percent of nickel; 12 to 24 weight percent of cobalt; 12 to 24 weight percent of iron; 12 to 24 weight percent in total of refractory elements comprising at least one of niobium, tantalum, tungsten, titanium, and vanadium; 12 to 24 weight percent of chromium; 6 to 13 weight percent of aluminum wherein a weight ratio of the aluminum to the chromium is in the range of 0.3 to 0.9; 0.1 to 2 total weight percent in total of rare earth elements comprising at least one of hafnium, yttrium, zirconium and other rare earth metals; whereby each of the nickel, cobalt, iron, chromium and the refractory elements has a concentration of no more than 24 weight percent.

### DETAILED DESCRIPTION OF THE INVENTION

The advantages of the invention will be better understood from the following detailed description of the embodiments thereof in connection. The disclosure is set out herein in various embodiments and with reference to various features, aspects and embodiments of the invention. The principles and features of this invention may be employed in various and numerous embodiments in various permutations and combinations without departing from the scope of the invention. The disclosure may further be specified as comprising, consisting or consisting essentially of, any of such permutations and combinations of these specific features, aspects, and embodiments, or a selected one or ones thereof.

All percentages are expressed herein as weight percentages, designated as wt %, based on a total weight of the material, unless specified otherwise.

The term “about” when referring to a measured value such as a concentration expressed in any unit, including wt %, duration and the like, is meant to encompass variations of +/−20%, +/−15%, +/−10%, +/−5%, +/−1%, +/−0.5% or +/−0.1% from the measured value.

Various aspects of the present invention may be presented in range format. Where a range of values describes a parameter, all sub-ranges, point values and endpoints within that range or defining a range are explicitly disclosed therein, unless explicitly disclosed otherwise. All physical property, dimension, concentration and ratio ranges and sub-ranges between range end points for those physical properties, dimensions, concentrations and ratios are considered explicitly disclosed herein, unless explicitly disclosed otherwise. For example, description of a range such as from 1 to 10 shall be considered to have specifically disclosed sub-ranges such as from 1 to 7, from 2 to 9, from 7 to 10 and so on, as well as individual numbers within that range such as 1, 5.3 and 9.

“High-temperature” means greater than 1600° F.

“High-temperature application” means an application having an oxidizing and corrosive environment that is greater than 1600° F.

“Material” means alloy substrate, powder and/or a coating.

“Conventional MCrAlY” means a state-of-the-art MCrAlY coating where M is either Ni, Co, or NiCo, whereby the MCrAlY coating may optionally include minor additions of various elements of Si, Re, and/or Hf, and M is present in the highest amount to act as the matrix element in the MCrAlY coating.

The inventors have observed that conventional MCrAlY coatings applied onto to the Ni-based and Co-based superalloys cannot perform satisfactorily in high-temperature applications. Specifically, the inventors have observed that conventional MCrAlY coatings exhibit accelerated environmental degradation and provide unacceptably short coating life that fails to meet applicable industrial requirements with increasing operating temperatures.

The inventors have discovered that insufficient performance of the conventional MCrAlY coatings in the high-temperature applications primarily occur from failure of the conventional MCrAlY coating chemistry at higher operating temperatures. The chemistry is believed to cause (i) faster interdiffusion between MCrAlY coating and the superalloy Ni-based or Co-based substrate as the operating temperature increases; (ii) insufficient chemical compatibility and detrimental phase formation at an interdiffusion zone located between the conventional MCrAlY coating and Ni-based or Co-based superalloy, where the Ni-based or Co-based superalloy contains a higher weight percentage of refractory elements; and (iii) accelerated oxidation and/or corrosion rates as the operating temperature increases.

The present invention has emerged from these shortcomings. The present invention relates to an alumina-forming and multi-element material for high-temperature applications. Particularly, this material of the present invention can be used a protective coating that can be applied onto the hot-sectional components of a gas turbine engine made of the nickel-based or cobalt based superalloys. The material has a formulation that sufficiently protect the nickel-based or cobalt-based superalloys from oxidation attack and corrosion attack which are typical of harsh operating environments. The new formulation of the present invention overcomes the drawbacks of conventional MCrAlY coatings for Ni-based and Co-based superalloys at higher operating temperatures (i.e., greater than 1600° F.) without reduction of coating life.

One embodiment of the present invention is directed to an alumina-forming and multi-element material suitable for usage in high-temperature applications. The material comprises the following formulation that is based on a total weight of the material as follows: (i) 12 to 24 weight percent of nickel; (ii) 12 to 24 weight percent of cobalt; (iii) 12 to 24 weight percent of iron; (iv) 12 to 24 weight percent in total of refractory elements comprising at least one of niobium, tantalum, tungsten, titanium and vanadium; (v) 12 to 24 weight percent of chromium; (vi) 6 to 13 weight percent of aluminum wherein a weight ratio of the aluminum to the chromium is in the range of 0.3 to 0.9; and (vii) 0.1 to 2 weight percent in total of rare earth elements comprising at least one of hafnium, yttrium, zirconium and other rare earth elements. Contrary to conventional MCrAlY coatings, the present invention requires that each of the nickel, cobalt, iron, chromium and the refractory elements have a concentration of no more than 24 weight percent. On the contrary, conventional MCrAlY, which is typically based on Ni, Co, or a NiCo matrix, contain one of these elements in a majority amount.

The multi-element formulation of the present invention does not have a matrix element such as Ni, Co or NiCo matrix, as occurs in conventional MCrAlY coatings. Such feature is an intended design objective of the present invention. Without being bound by any particular theory, a higher configurational entropy of mixing is created by the formulation of the present invention not having a matrix element. The higher configurational entropy of mixing is believed to lead to a much more sluggish interdiffusion between elements. Such a sluggish interdiffusion can increase the high-temperature creep strength. Additionally, if such multi-element materials are used as a protective coating, a sluggish interdiffusion can reduce loss of key elements within the coating by slower interdiffusion with the substrate during high-temperature exposure, thereby allowing a longer coating life.

Another novel aspect of the present invention is that the amount of Al and Cr are interdependent such that they must be maintained in a weight ratio of Al to Cr in a range of 0.3 to 0.9 with Al permitted to range from 6 wt % to 13 wt % and Cr permitted to range from 12 wt % to 24 wt %. The Al wt %, Cr wt % and weight ratio of Al/Cr promote the formation of a continuous and thermally-grown alumina protective scale during operation at high temperatures of greater than 1600° F., but without significantly sacrificing ductility.

Another unique aspect of the present invention is that the formulations of the present invention create improved chemical compatibility between the coating and the Ni-based or Co-based superalloy substrate or a refractory-metal alloy substrate as a result of 12 to 24 weight percent in total of refractory elements comprising at least one of niobium, tantalum, tungsten, titanium and vanadium. The improved chemically compatibility between coating and superalloy substrate or refractory-metal alloy substrate leads to reduced, minimal or absence of detrimental phases in the interdiffusion zone located between the coating and superalloy substrate or refractory metal alloy substrate in comparison to conventional MCrAlY coatings. The detrimental phases can reduce coating performance in terms of lower resistance to oxidation and corrosion and mechanical properties.

Other favorable properties as a result of the novel formulations are (i) the melting point or liquidus temperature is greater than 1400° C. and the ductile-brittle-transition-temperature is less than 600° C.; and (ii) the microstructure contains two coherent body-centered-cubic (BCC) phases with phase domain size in the range of 0.05 micrometer to 0.8 micrometer. The submicron and coherent microstructure is believed to promote the formation of an exclusive and protective alumina scale during operation at high temperatures of greater than 1600° F. By contrast, the conventional MCrAlY compositions contain incoherent face-centered cubic phase (FCC) and body-centered cubic (BCC) phase with phase domain size in the range of several to tens micrometers, which can result in nonprotective transient oxide formation on the aluminum-lean FCC phase, and therefore fair oxidation performance.

Additionally, the formulations of the present invention are preferably high purity as a result of only trace impurities of carbon, oxygen and nitrogen allowed in the formulation. Specifically, in a preferred embodiment, the material comprises less than about 0.05 weight percent of carbon; less than about 0.05 weight percent of oxygen; and less than about 0.03 weight percent of nitrogen. Higher impurity levels of oxygen, carbon and nitrogen can result in material degradation in high-temperature applications as a result of poor oxidative resistance performance and faster oxidation rates. The carbon, nitrogen and oxygen trace impurities can be measured by conventional measurement techniques, such as commercially available combustion analysis techniques.

In another embodiment, the alumina-forming and multi-element material has a formulation that comprises (i) 15 to 20 weight percent of nickel; (ii) 15 to 20 weight percent of cobalt; (iii) 15 to 20 weight percent of iron; (iv) 15 to 20 weight percent in total of the refractory elements comprising at least one of niobium, tantalum, tungsten, titanium, and vanadium; (v) 15 to 20 weight percent of chromium; (vi) 8 to 12 weight percent of aluminum, in which the weight ratio of the aluminum to chromium is in the range of 0.4 to 0.8; and (vii) 0.1 to 2 weight percent in total of rare earth elements comprising at least one of hafnium, yttrium, zirconium and other rare earth elements. Each of the nickel, cobalt, chromium, iron and refractory elements remain no greater than 20 wt % in order to avoid a matrix element as mentioned hereinabove, in accordance with the principles of the present invention.

Preferably, the materials of the present invention exclude rhenium, manganese, silicon or copper or any combination thereof. The absence of one or more of these elements is believed to improve performance. For example, rhenium, while taught in the prior art to be a necessary additive for improved performance, can be excluded in the present invention as a result of the benefits realized from the novel formulation disclosed herein. As a result of its exclusion in the present invention, the cost of the formulation can be substantially reduced in comparison to conventional MCrAlY materials that require rhenium, platinum, palladium or other high cost precious metals (e.g., as disclosed in U.S. Pat. Nos. 5,401,307 and 5,154,885).

The formulations of the present invention allow the material to be used a protective coating that is applied onto the hot-sectional components of a gas turbine engine made of nickel-based or cobalt-based superalloys, or refractory metal alloys, and protects the nickel- or cobalt-based superalloy, or refractory metal alloys from oxidation and corrosion attack during high-temperature applications, which represent harsh operating environments. In this manner, the present invention offers the ability to successfully operate in high temperature applications and therefore represent a notable improvement over conventional MCrAlY coatings.

The present invention offers several benefits not possible with current state-of-the art MCrAlY coatings in high temperature applications. For example, by utilizing the novel formulations of the present invention on aircraft, industrial, and marine gas turbine engines that operate in high temperature applications, the fuel efficiency can be improved, thereby reducing fuel consumption and cost as well as CO2 emissions.

It should be understood that the principles of the present invention have wide applicability. For example, a substrate can be made in accordance with the formulations of present invention. In particular, an alloy with relatively larger amounts of refractory elements incorporated therein can be formulated to have a composition as described herein. Such novel alloy is expected to operate for extended durations in high temperature applications, which represents a notable improvement from current superalloy substrates that are unable to do so, even with the addition of a protective MCrAlY conventional coating.

Additionally, the formulation of the present invention as a coating can be used as a standalone environmental resistant coating. Alternatively, the present invention as a coating can be configured as a bond coat for thermal barrier coating systems. One or more thermal barrier coatings can be applied over the bond coat.

The formulations of the present invention can also be used as a starting material to make nano-precipitate strengthened, multi-element alloys or coatings with improved oxidation and/or corrosion resistance and improved mechanical properties.

Still further, it should be understood that the coating composition of present invention can be used as a high-temperature protection coating in other industrial process besides gas turbine engines. This includes but is not limited to coal gasifiers, petroleum refining, concentrated solar power and steam methane cracking.

While it has been shown and described what is considered to be certain embodiments of the invention, it will, of course, be understood that various modifications and changes in form or detail can readily be made without departing from the spirit and scope of the invention. It is, therefore, intended that this invention not be limited to the exact form and detail herein shown and described, nor to anything less than the whole of the invention herein disclosed and hereinafter claimed.

1. An alumina-forming and multi-element material suitable for usage in high-temperature applications, the material comprising the following formulation based on a total weight of the material:
12 to 24 weight percent of nickel;
12 to 24 weight percent of cobalt;
12 to 24 weight percent of iron;
12 to 24 weight percent in total of refractory elements comprising at least one of niobium, tantalum, tungsten, titanium and vanadium;
12 to 24 weight percent of chromium;
6 to 13 weight percent of aluminum wherein a weight ratio of the aluminum to the chromium is in the range of 0.3 to 0.9;
0.1 to 2 weight percent in total of rare earth elements comprising at least one of hafnium, yttrium, zirconium and other rare earth elements;
whereby each of the nickel, cobalt, iron, chromium and the refractory elements has a concentration of no more than 24 weight percent.

2. The alumina-forming and multi-element material of claim 1, further comprising a melting point or liquidus temperature greater than 1400° C.

3. The alumina-forming and multi-element material of claim 1, further comprising a ductile-brittle-transition-temperature less than 600° C.

4. The alumina-forming and multi-element material of claim 1, further comprising a microstructure containing two coherent body-centered-cubic (BCC) phases with phase domain size in a range of 0.05 micrometer to 0.8 micrometer.

5. The alumina-forming and multi-element material of claim 1, wherein said material excludes rhenium, manganese, silicon, copper or any combination thereof.

6. The alumina-forming and multi-element material of claim 1, said material comprising less than about 0.05 weight percent of carbon, less than about 0.05 weight percent of oxygen, and less than about 0.03 weight percent of nitrogen.

7. The alumina-forming and multi-element material of claim 1, said material further comprising:
15 to 20 weight percent of nickel;
15 to 20 weight percent of cobalt;
15 to 20 weight percent of iron;
15 to 20 weight percent in total of the refractory elements comprising at least one of niobium, tantalum, tungsten, titanium, and vanadium;
15 to 20 weight percent of chromium;
8 to 12 weight percent of aluminum, wherein the weight ratio of the aluminum to chromium is in the range of 0.4 to 0.8.

8. A method of protecting a substrate from high-temperature oxidation and corrosion, comprising the steps of:
providing a substrate made of a nickel-based or a cobalt-based superalloy or a refractory-metal alloy;
applying onto the substrate an alumina-forming and multi-element coating, said coating comprises the following elements:
12 to 24 weight percent of nickel;
12 to 24 weight percent of cobalt;
12 to 24 weight percent of iron;
12 to 24 weight percent in total of refractory elements comprising at least one of niobium, tantalum, tungsten, titanium, and vanadium;
12 to 24 weight percent of chromium;
6 to 13 weight percent of aluminum wherein a weight ratio of the aluminum to the chromium is in the range of 0.3 to 0.9;
0.1 to 2 total weight percent in total of rare earth elements comprising at least one of hafnium, yttrium, zirconium and other rare earth metals;
whereby each of the nickel, cobalt, iron, chromium and the refractory elements has a concentration of no more than 24 weight percent.

9. The alumina-forming and multi-element material of claim 1, wherein said material is a superalloy substrate.

10. The alumina-forming and multi-element material of claim 1, wherein said material is a coating or a powder composition.

11. The alumina-forming and multi-element material of claim 1, wherein said material is a coating applied onto a superalloy substrate or a refractory metal alloy substrate, and further wherein the coating exhibits reduced detrimental phase forms in an interdiffusion zone between the coating and the superalloy substrate or the refractory metal alloy substrate in comparison to a conventional MCrAlY coating.

12. The alumina-forming and multi-element material of claim 1, wherein said material is a coating applied onto a superalloy substrate with elevated levels of refractory elements or a refractory metal alloy substrate, and further wherein the coating exhibits increased chemical compatibility with the superalloy substrate with the elevated levels of refractory elements or the refractory metal alloy substrate in comparison to a conventional MCrAlY coating.

13. The alumina-forming and multi-element material of claim 7, further comprising the step of applying a thermal barrier coating onto the alumina-forming and multi-element coating.
